(19) United States
(12) Patent Application Publication
(10) Pub. No.: US 2009/0272693 A1
(43) Pub. Date: Nov. 5, 2009

(54) Utilization of polysaccharides to eliminate anions of heavy metals from water

(75) Inventors: Caroline Mabille, Sevran (FR); Vincent Monin, Corbas (FR); Yves Mottot, Puteaux (FR); Jean-Francois Sassi, Saint-Romain En Jarez (FR)

Correspondence Address: BUCHANAN, INGERSOLL & ROONEY PC, POST OFFICE BOX 1404, ALEXANDRIA, VA, 22313-1404, US

(73) Assignee: RHODIA CHIME, AUBERVILLIERS CEDEX (FR)

(21) Appl. No.: 11/919,338

(22) PCT Filed: Apr. 21, 2006
(86) PCT No.: PCT/FR2006/000889

§ 371 Date: Jun. 12, 2009

(30) Foreign Application Priority Data
Apr. 28, 2005 (FR) 0504295

(51) Int. Cl. C02F 1/42

(52) U.S. Cl. 210/683

(57) ABSTRACT

Water contaminated with anions of heavy metals, e.g., arsenic values, is purified by contacting same with a composition containing at least one polysaccharide, such as starches or vegetable gums.

The invention relates to the field of water treatment, in particular to the removal of metals present in the form of anions in water and more particularly to the removal of arsenic from natural water, industrial water and wastewater.

Certain metals present in water may in particular cause many health problems due to their toxicity. The metals present in natural water are mainly of natural origin. For example, arsenic comes from the dissolution of arsenic As (III) or As (V) present in the rocks which surround the water tables. In certain regions of the world, the concentration of arsenic present in natural water may reach values of a few hundred of μg/l.

The removal of toxic metals such as arsenic, antimony, tin, vanadium, germanium, molybdenum and tungsten from water is therefore a prime objective for ensuring the quality of drinking water produced from natural waters. In Europe, the European Directive 98/83 EC of 3 Nov. 1998 thus imposes, for drinking water, a level of arsenic less than 10 μg/l and for antimony less than 5 μg/l, this limit also being recognized by the World Health Organization.

To date, in order to remove arsenic, it is known to use alumina alone. Also described in patent CA 1067627 is the possibility of using an oxide and/or hydroxide of iron previously deposited on a support that incorporates alumina. However, one of the drawbacks of this system is the need to previously prepare a product based on iron hydroxide on the alumina. Furthermore, when the amount of iron hydroxide deposited on the alumina is not high enough and when there is then a gap in the presence of iron hydroxide in contact with the alumina, it is not possible to add iron hydroxide during the process.

There is a need to find a means of removing metals such as arsenic that does not, in particular, have the aforementioned drawbacks.

One of the objects of the present invention is therefore to find a means for removing metals such as arsenic which could make it possible, in particular, to obtain a greater retention than the means known to date.

Another object of the present invention is to provide a means of removing metals such as arsenic from water which is inexpensive with regard to investments and production.

The Applicant has discovered a means of purifying water according to a simple process that meets the objectives described above and which consists in bringing into contact the water to be purified and a particularly well-suited polysaccharide.

The first subject of the invention is therefore the use of a composition comprising at least one polysaccharide for purifying water loaded with metals.

According to the use of the invention, the metals to be removed, generally present in the form of anions in the water, are chosen from the group consisting of arsenic, antimony, tin, vanadium, germanium, molybdenum and tungsten. More preferably, the use of the invention is applied to the removal of arsenic.

The form in which arsenic is found in aqueous solution strongly depends on the pH. For As(V), it is in neutral form at pH<3, then anionic form above that. As for As (III); it is in cationic form at pH<2, neutral form between 2<pH<9 and anionic form above that.

No particular limitation is imposed on the polysaccharides to be used according to the invention. By way of indication, all those described in the review “Progress in Polymer Science”, 30, (2005), 38-70 may be used.

According to one particular form of the invention, the polysaccharide is chosen from the group comprising cellulose, starches and vegetable gums.

The cellulose may be of any origin, for example of vegetable, bacterial, animal, fungal or amoebic origin, preferably of vegetable, bacterial or animal origin. As an example of vegetable sources of cellulose, mention may be made of wood, cotton, linen, ramie, certain algae, jute, waste from agrofood industries, or the like. As examples of animal sources of cellulose, mention may be made of animals from the tunicate family.

The starch may be chosen from wheat starch, potato starch, cornstarch, sweet potato starch, tapioca starch, cassava starch, sago starch, rice starch, glutinous cornstarch, waxy cornstarch and cornstarch with a high amylose content, or mixtures thereof. The starch may be used as is or after having undergone a pregelatinization pretreatment such as, for example, cooking in hot water or steam. Preferably, corn, wheat or potato starch is chosen.

No particular limit is imposed on the purity of the starch. In this sense, natural starch-rich flours may also be used, such as for example cereal flour such as wheat flour or corn flour, or else potato flour.

The term “starch” used subsequently denotes both purified starches and natural flours.

No particular limit is imposed on the vegetable gum used in the invention, and examples of vegetable gums that can be used comprise glucomannans such as Konjac, xyloglucans such as tamarind gum, galactomannans such as guar, carob, tara, fenugreek or “mesquite” gum, or gum arabic or mixtures thereof. Preferably, galactomannans and in particular guars are preferred.

No particular limit is imposed on the purity of the vegetable gum. In this sense, natural flours rich in vegetable gum may also be used, such as for example native guar powder or native carob powder without any refining, or mixtures thereof.

The term “vegetable gum” used subsequently denotes both purified vegetable gums and natural flours.

According to one embodiment of the invention, the polysaccharide is optionally modified to improve its affinity for the metals to be removed, and therefore to improve its ability to capture these metals, on the one hand, and to make it insoluble, on the other hand, which allows it to be separated more easily from the liquid solution to be treated. These modifications intended to improve the affinity of the polysaccharide and to make it insoluble may be carried out separately and in any order desired. It may also be possible to carry out these modifications simultaneously.

Among the modifications to be carried out, mention may be made of the introduction of cationic or cationizable groups. The term “cationizable groups” is understood to mean groups which may be rendered cationic as a function of the pH of the medium. (Preferred pH: for example pH>9 for tertiary amine functional groups).

Among the cationic or cationizable groups, mention may be made of groups comprising quaternary ammoniums or primary, secondary or tertiary amines, pyrridiniums, guanidiniums, phosphoniums or sulfoniums.

The modified cationic polysaccharides that are used in the invention may be obtained by reacting, in the customary manner, the polysaccharide raw materials mentioned above.

The introduction of cationic or cationizable groups into the polysaccharide may be carried out via a nucleophilic substitution reaction.

In the case where it is desired to introduce an ammonium group, the suitable reagent used may be:
(3-chloro-2-hydroxypropyl)trimethylammonium chloride, especially sold under the name QUAB 188 by Degussa;
an epoxide bearing a quaternary ammonium such as (2,3-epoxypropyl)trimethylammonium chloride, especially sold under the name QUAB 151 by Degussa, or similar compounds;
(diethylamino)ethyl chloride;
   or Michael acceptors such as, for example, acrylates or methacrylates bearing quaternary ammoniums or tertiary amines.

The introduction of cationic or cationizable groups into the polysaccharide may be carried out via an esterification with amino acids such as, for example, glycine, lysine, arginine, 6-aminocaproic acid, or with quaternized amino acid derivatives such as, for example, betaine hydrochloride.

The introduction of cationic or cationizable groups into the polysaccharide may also be carried out via a radical polymerization comprising the grafting of monomers that comprise at least one cationic or cationizable group to the polysaccharide.

The radical initiation may be carried out using cerium as is described in the publication European Polymer Journal, Vol. 12, p. 535-541, 1976. The radical initiation may also be carried out by an ionizing radiation and in particular an electron beam bombardment.

The monomers that comprise at least one cationic or cationizable group used to carry out this radical polymerization may be, for example, monomers that comprise at least one ethylenic unsaturation and at least one quaternary nitrogen atom or nitrogen atom that can be quaternized by adjusting the pH.

Among these monomers that comprise at least one ethylenic unsaturation and at least one quaternary nitrogen atom or nitrogen atom that can be quaternized by adjusting the pH, mention may be made of the compounds of formulae (I), (II), (III), (IV) or (V) below:
the compound of general formula (I):

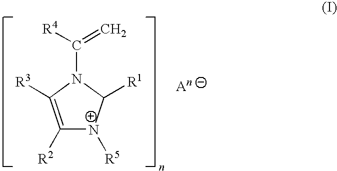

in which:
A^{n\textcircled{-}} represents a Cl^{\textcircled{-}}, Br^{\textcircled{-}}, I^{\textcircled{-}}, SO₄^{2\textcircled{-}}, CO₃^{2\textcircled{-}}, CH₃—OSO₃^{\textcircled{-}}, OH^{\textcircled{-}} or CH₃—CH₂—OSO₃^{\textcircled{-}} ion;
R¹ to R⁵ being identical or different represent, independently of one another, an alkyl group having from 1 to 20 carbon atoms, a benzyl radical or an H atom; and
n is equal to 1 or 2; or
   the compound of general formula (II):

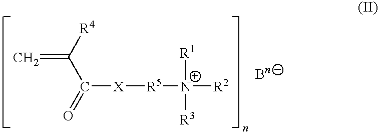

in which:
X represents an —NH group or an atom of oxygen O;
R⁴ represents a hydrogen atom or an alkyl group having from 1 to 20 carbon atoms;
R⁵ represents an alkene group having from 1 to 20 carbon atoms;
R¹, R², & R³ being identical or different represent, independently of one another, an alkyl group having from 1 to 20 carbon atoms;
B^{n\textcircled{-}} represents a Cl^{\textcircled{-}}, Br^{\textcircled{-}}, I^{\textcircled{-}}, SO₄^{2\textcircled{-}}, CO₃^{2\textcircled{-}}, CH₃—OSO₃^{\textcircled{-}}, OH^{\textcircled{-}} or CH₃—CH₂—OSO₃^{\textcircled{-}} ion; and
n is equal to 1 or 2; or
   the compound of general formula (III):

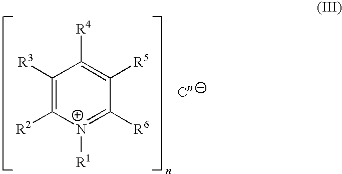

in which:
R¹ to R⁶ being identical or different represent, independently of one another, a hydrogen atom or an alkyl group having from 1 to 20 carbon atoms, but with one of the groups R¹ to R⁶ representing a —CH═CH₂ group;
C^{n\textcircled{-}} represents a Cl^{\textcircled{-}}, Br^{\textcircled{-}}, I^{\textcircled{-}}, SO₄^{2\textcircled{-}}, CO₃^{2\textcircled{-}}, CH₃—OSO₃^{\textcircled{-}}, OH^{\textcircled{-}} or CH₃—CH₂—OSO₃^{\textcircled{-}} ion; and
n is equal to 1 or 2; or
   the compound of general formula (IV):

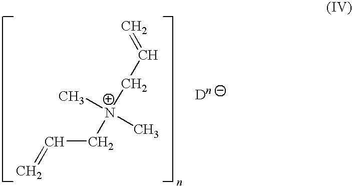

in which:
D^{n\textcircled{-}} represents a Cl^{\textcircled{-}}, Br^{\textcircled{-}}, I^{\textcircled{-}}, SO₄^{2\textcircled{-}}, CO₃^{2\textcircled{-}}, CH₃—OSO₃^{\textcircled{-}}, OH^{\textcircled{-}} or CH₃—CH₂—OSO₃^{\textcircled{-}} ion; and
n is equal to 1 or 2.

Preferably, the monomers comprising at least one ethylenic unsaturation and at least one quaternary nitrogen atom or nitrogen atom that can be quaternized are chosen from:
2-dimethylaminoethyl acrylate (ADAM);
quaternized 2-dimethylaminoethyl acrylate (ADAM-Quat);
2-dimethylaminoethyl methacrylate (MADAM);
quaternized 2-dimethylaminoethyl methacrylate (MADAM-Quat);
2-diethylaminoethyl methacrylate quaternized in chloride form, in particular known as PLEXIMON 735 or TMAE MC 80 by Röhm;
diallyldimethylammonium chloride (DADMAC);
trimethyl ammonium propyl methacrylamide in chloride form, in particular known as MAPTAC; or
mixtures thereof.

The modified cationic polysaccharide may contain cationic or cationizable units derived from a chemical conversion, after polymerization, of precursor monomers of cationic or cationizable functional groups. Mention may be made, by way of example, of poly(p-chloromethylstyrene) which after reaction with a tertiary amine such as a trimethylamine forms quaternized poly(para-trimethylaminomethylstyrene).

The cationic or cationizable units are combined with negatively charged counter ions. These counter ions may be chosen from chloride, bromide, iodide, fluoride, sulfate, methylsulfate, phosphate, hydrogenphosphate, phosphonate, carbonate, hydrogencarbonate or hydroxide ions. Preferably, counter ions chosen from hydrogenphosphates, methylsulfates, hydroxides and chlorides are used.

The degree of substitution of the modified cationic polysaccharides used in the invention is at least 0.01, and preferably at least 0.1. When the degree of substitution is less than 0.01, the effectiveness of the implementation of the removal is reduced. When the degree of substitution exceeds 0.1, the polysaccharide inevitably swells in the liquid. In order to be able to use a modified polysaccharide substituted to a level greater than 0.1, it is preferable to make it undergo a modification to render it insoluble. These modifications are described later on.

The degree of substitution of the modified cationic polysaccharide corresponds to the average number of cationic charges per sugar unit.

Among the modifications of the polysaccharide intended to improve its affinity, mention may also be made of the introduction of uncharged hydrophilic or hydrophobic groups.

Among the hydrophilic groups that can be introduced, mention may especially be made of one or more saccharide or oligosaccharide residues, one or more ethoxy groups, one or more hydroxyethyl groups or an oligo(ethylene oxide).

Among the hydrophobic groups that can be introduced, mention may especially be made of an alkyl, aryl, phenyl, benzyl, acetyl, hydroxybutyl or hydroxypropyl group, or a mixture thereof.

The expression “alkyl or aryl or acetyl radical” is understood to mean preferably alkyl or aryl or acetyl radicals having from 1 to 22 carbon atoms.

The degree of substitution of the vegetable gums modified by uncharged hydrophilic or hydrophobic groups that are used in the invention is at least 0.01, and preferably at least 0.1.

The degree of substitution of the polysaccharide modified by uncharged hydrophilic or hydrophobic groups corresponds to the average number of the uncharged hydrophilic or hydrophobic groups per sugar unit.

It is possible to carry out several of the modifications proposed above intended to increase the affinity of the polysaccharide with respect to the metals to be removed on one and the same polysaccharide.

Among the modifications of the polysaccharide intended to make it insoluble, mention may especially be made of the possibility of carrying out chemical crosslinking of the polysaccharide, or else of chemically or physically adsorbing it onto a mineral or organic support that is insoluble in water.

Preferably, chemical crosslinking of the polysaccharide is used to make it insoluble. Chemical crosslinking of the polysaccharide may be obtained by the action of a crosslinking agent chosen from formaldehyde, glyoxal, halohydrins such as epichlorohydrin or epibromohydrin, phosphorus oxychloride, polyphosphates, diisocyanates, bisethyleneurea, polyacids such as adipic acid, citric acid, acrolein, and the like. Chemical crosslinking of the polysaccharide may also be obtained by the action of a metal complexing agent, such as for example Zirconium (IV) or sodium tetraborate. Chemical crosslinking of the polysaccharide may also be obtained under the effect of an ionizing radiation.

The degree of insolubilization of the polysaccharide is satisfactory when the mass fraction of soluble organics in the polysaccharide is less than 10%.

As indicated previously, the modifications intended to improve the affinity of the polysaccharide for the metals, and the modifications intended to make it insoluble may be carried out separately and in any order desired. It may also be possible to carry out these modifications simultaneously. By way of example, where the modifications of the polysaccharide are carried out simultaneously, mention may be made of an insoluble cationic vegetable gum obtained by bringing the polysaccharide together with epichlorohydrin in excess and a trimethylamine. The epichlorohydrin generates, in situ, a reagent bearing a quaternary ammonium which will make it possible to render the polysaccharide cationic on the one hand. The epichlorohydrin in excess makes it possible, on the other hand, to crosslink the polysaccharide.

The optionally modified and optionally insoluble polysaccharide of the invention may be used in powder form or else be formed into granules.

The chemical crosslinking reaction can be exploited to obtain insoluble granules.

The optionally modified starches may be formed by granulation during the crosslinking reaction in order to obtain insoluble particles of the order of a millimeter (for example between 200 μm and 5 mm), which makes it possible to easily remove them from the medium to be treated.

In an industrial installation, these granulated products have the advantage of being able to be used in a column, in the same way as exchange resins, thus offering a large area for exchange while limiting the pressure drop.

It is possible to use the optionally modified and optionally insoluble polysaccharide of the invention alone, or else as a mixture with other trapping agents such as, for example, exchange resins.

It is possible to mix the optionally modified and optionally insoluble polysaccharide of the invention with inert fillers such as polymer powder or sand in order to ballast it.

The following examples illustrate the invention without limiting the scope thereof.

### EXAMPLES

### Example of Preparing a Starch According to the Invention

### Synthesis of an Insolubilized Cationic Starch (Starch A)

Introduced into a 1 liter jacketed reactor, equipped with an anchor-type mechanical stirrer, a dropping funnel and a condenser, were 75 ml of demineralized water, then 750 mg of sodium chloride and 50 g of waxy cornstarch. The mixture was placed under a nitrogen atmosphere and stirred at 100 rpm. 5.2 ml of epibromohydrin were introduced, the mixture was stirred for 3 minutes, then 3 g of sodium hydroxide pellets dissolved in 20 ml of demineralized water were added. The reaction medium took on a very viscous pasty appearance. The stirring was then stopped and the mixture was left to react at rest at ambient temperature (25° C.) for 16 hours. At the end of this time, the reaction mixture had become fiable. A solution of 23 g of sodium hydroxide pellets in 60 ml of demineralized water was added and the stirring was restarted at 100 rpm. The paste disintegrated and dispersed in the liquid. After 30 minutes, the reaction mixture was heated to 65° C. Once at this temperature, 90 ml of QUAB 188 (chlorohydroxypropyl trimethylammonium chloride at 69% in water sold by Degussa AG) were added dropwise over 30 minutes. When the addition was finished, the reactor was kept at the temperature of 60° C. with stirring for 2 hours. The stirring was then stopped and the reaction mixture was left to cool to ambient temperature. The mixture was left to stand for 2 hours in order for the solid to settle. The supernatant was removed by suction using a filter-tipped cannula, then 600 ml of demineralized water were reintroduced into the reactor. The reaction mixture was brought to pH=6 by addition of 1 N hydrochloric acid. It was then stirred for 2 hours. The solid+liquid mixture was then filtered through a No. 3 sinter funnel. The filter cake was taken up in 1 liter of demineralized water heated to 70° C. with vigorous stirring for 2 hours, at the end of which the stirring was stopped and it was left to settle. The supernatant was removed by suction using a filter-tipped cannula. The operation of washing by redispersion in 1 liter of demineralized water, settling and removal of the supernatant was repeated 4 times with cold water. At the end of the final washing operation, the solid which settled was separated then frozen and dried by freeze-drying.

60 g of very aerated white powder were obtained, which powder was easily impregnated by water but did not dissolve.

Elementary analysis on nitrogen showed that this product had a cationic DS of 0.12.

### Examples of Evaluating a Starch of the Invention

In the two examples given below, the arsenic assays were carried out by ICP/MS (Inductively Coupled Plasma/Mass Spectrometer) with an uncertainty of 10%. The samples to be analyzed were immediately acidified with nitric acid after their removal, then stored in the refrigerator in polyethylene flasks.

### Example 1

In this test, the As(V) adsorption capacity of the crosslinked cationic starch, Starch A, was determined at neutral pH and at a temperature of 7° C.

A mother solution of arsenic (V) with a concentration of 500 mg/l was prepared from arsenic oxide As₂O₅. Daughter solutions, with concentrations varying from 1 to 50 mg of As/I, were prepared just before use by diluting the mother solution.

For each of the daughter solutions, in a 150 ml Pyrex beaker, 42.5 mg of starch A were introduced with stirring to 100 ml of the solution to be treated. The pH of the suspensions was adjusted to pH 7 with concentrated solutions of NaOH and HCl.

After a contact time of 15 hours (>>equilibrium time) at 7° C., the supernatants of the suspensions were recovered by filtration in order to assay their residual arsenic content. For the filtration, PVDF Millex syringe filters having a porosity of 0.45 μm were used.

The results are given in the table below.

| | As(V) concentration | |
|---|---|---|
| Initial As(V) | after 15 hours contact | As(V) adsorption |
| concentration (mg/l) | (mg/l) | capacity (mg/l) |
| 6 | 0.37 | 13 |
| 4 | 0.026 | 10 |
| 9 | 1.1 | 17 |
| 16 | 6.5 | 23 |
| 25 | 8.9 | 38 |
| 32 | 18 | 33 |
| 41 | 24 | 39 |

This test demonstrated the effectiveness of crosslinked cationic starch for removing As(V) at neutral pH and at a temperature of 7° C. Furthermore, it can be noted that the product has a maximum adsorption capacity of around 40 mg of As/gram of solid.

### Example 2

This test was carried out on a natural water from the Rennes region which had been clarified by a coagulation/flocculation treatment, and which was then doped with arsenic (V) equal to 100 μg of As(V)/liter by using a solution of arsenic oxide As₂O₅.

For this test, 42.5 mg of crosslinked cationic starch “Starch A” to be tested were introduced, with stirring and at a temperature of 7° C., into 100 ml of doped clarified water and after a contact time of 15 hours, the suspension was filtered using a PVDF Millex syringe filter having a porosity of 0.45 μm, in order to recover therefrom its supernatant and assay the residual concentrations of natural organic matter and of arsenic.

The assay of the natural organic matter was carried out by UV spectrophotometry at 254 nm with a Shimadzu UV-160 model 204-04550 machine.

The results are given in the table below.

| | UV absorbance at 254 nm | | As(V) concentration | |
|---|---|---|---|---|
| | | After a 15 h | | After a 15 h |
| | T = 0 | contact time | T = 0 | contact time |
| Undoped clarified | 0.190 +/− 0.005 | 0.120 +/− 0.002 | <5 | |
| water | | | | |
| Clarified water | 0.190 +/− 0.005 | 0.104 +/− 0.002 | 93 | 44 |
| doped with As(V) | | | | |
| equal to 100 μg/l | | | | |

This example demonstrates that when it is used to treat a natural water, the crosslinked cationic starch makes it possible to remove a fraction of the natural organic matter but also some of the arsenic present in this water.

Under the test conditions (7° C., neutral pH, [starch]=425 mg/l, contact time=15 h, [As(V)]˜100 μg/l), the treatment with starch A made it possible to remove around 45% of the natural organic matter that absorbs in UV at 254 nm and 45% of the arsenic (V).

1.-26. (canceled)

27. A process for the purification of water containing contaminating amounts of anions of heavy metals selected from the group consisting of arsenic, antimony, tin, vanadium, germanium, molybdenum and tungsten, comprising contacting such impure water with a purifying composition which comprises at least one polysaccharide.

28. A process for the purification of water containing contaminating amounts of anions of arsenic values, comprising contacting such impure water with a purifying composition which comprises at least one polysaccharide.

29. The process as defined by claim 28, wherein the polysaccharide is selected from the group consisting of cellulose, starches and vegetable gums.

30. The process as defined by claim 29, said polysaccharide comprising a cellulose of vegetable, bacterial, animal, fungal or amoebic origin.

31. The process as defined by claim 29, said polysaccharide comprising a starch selected from the group consisting of wheat starch, potato starch, cornstarch, sweet potato starch, tapioca starch, cassava starch, sago starch, rice starch, glutinous cornstarch, waxy cornstarch, cornstarch having a high amylose content, and mixtures thereof.

32. The process as defined by claim 31, wherein the starch is pregelatinized.

33. The process as defined by claim 29, said polysaccharide comprising a vegetable gum selected from the group consisting of glucomannans, Konjac, xyloglucans, tamarind gum, galactomannans, guar, carob, tara, fenugreek, “mesquite” gum, gum arabic and mixtures thereof.

34. The process as defined by claim 33, wherein the vegetable gum comprises a galactomannan.

35. The process as defined by claim 28, wherein the polysaccharide is modified and comprises one or more cationic or cationizable functional groups.

36. The process as defined by claim 35, wherein the cationic or cationizable functional groups are selected from among quaternary ammoniums, tertiary amines, pyrridiniums, guanidiniums, phosphoniums or sulfoniums.

37. The process as defined by claim 35, comprising introduction of cationic or cationizable groups into a vegetable derivative via a nucleophilic substitution reaction.

38. The process as defined by claim 35, comprising introduction of cationic or cationizable groups via an esterification with amino acids, or with quaternized amino acid compounds.

39. The process as defined by claim 35, comprising introduction of cationic or cationizable groups via a radical polymerization which comprises the grafting of monomers containing at least one cationic or cationizable group onto the polysaccharide.

40. The process as defined by claim 39, wherein the monomers that comprise at least one cationic or cationizable group to carry out such radical polymerization are selected from among the compounds of formulae (I), (II), (III) or (IV) below:
the compound of general formula (I): 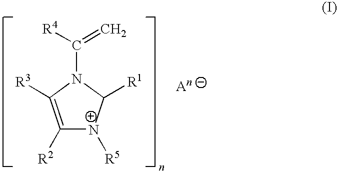
in which:
A^{n\textcircled{-}} represents a Cl^{\textcircled{-}}, Br^{\textcircled{-}}, I^{\textcircled{-}}, SO₄^{2\textcircled{-}}, CO₃^{2\textcircled{-}}, CH₃—OSO₃^{\textcircled{-}}, OH^{\textcircled{-}} or CH₃—CH₂—OSO₃^{\textcircled{-}} ion;
R¹ to R⁵, which may be identical or different, are each an alkyl radical having from 1 to 20 carbon atoms, a benzyl radical or an H atom; and
n is equal to 1 or 2; or
the compound of general formula (II): 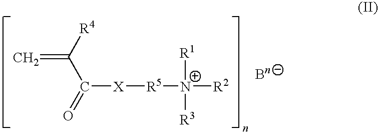
in which:
X represents an —NH group or an atom of oxygen O;
R⁴ represents a hydrogen atom or an alkyl radical having from 1 to 20 carbon atoms;
R⁵ represents an alkene group having from 1 to 20 carbon atoms;
R¹, R², & R³, which may be identical or different, are each an alkyl radical having from 1 to 20 carbon atoms;
B^{n\textcircled{-}} represents a Cl^{\textcircled{-}}, Br^{\textcircled{-}}, I^{\textcircled{-}}, SO₄^{2\textcircled{-}}, CO₃^{2\textcircled{-}}, CH₃—OSO₃^{\textcircled{-}}, OH^{\textcircled{-}} or CH₃—CH₂—OSO₃^{\textcircled{-}} ion; and
n is equal to 1 or 2; or
the compound of general formula (III): 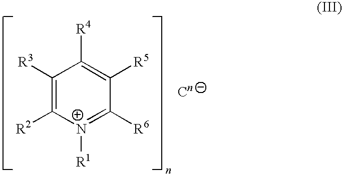
in which:
R¹ to R⁶, which may be identical or different, are each a hydrogen atom or an alkyl radical having from 1 to 20 carbon atoms, with the proviso that one of the groups R¹ to R⁶ is a —CH═CH₂ group;
C^{n\textcircled{-}} represents a Cl^{\textcircled{-}}, Br^{\textcircled{-}}, I^{\textcircled{-}}, SO₄^{2\textcircled{-}}, CO₃^{2\textcircled{-}}, CH₃—OSO₃^{\textcircled{-}}, OH^{\textcircled{-}} or CH₃—CH₂—OSO₃^{\textcircled{-}} ion; and
n is equal to 1 or 2; or
the compound of general formula (IV): 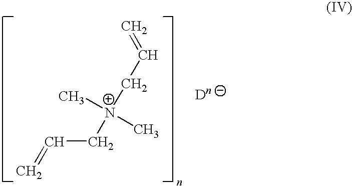
in which:
D^{n\textcircled{-}} represents a Cl^{\textcircled{-}}, Br^{\textcircled{-}}, I^{\textcircled{-}}, SO₄^{2\textcircled{-}}, CO₃^{2\textcircled{-}}, CH₃—OSO₃^{\textcircled{-}}, OH^{\textcircled{-}} or CH₃—CH₂—OSO₃^{\textcircled{-}} ion; and
n is equal to 1 or 2.

41. The process as defined by claim 39, wherein the monomers that comprise at least one cationic or cationizable group to carry out such radical polymerization are selected from the group consisting of:
2-dimethylaminoethyl acrylate (ADAM);
quaternized 2-dimethylaminoethyl acrylate (ADAM-Quat);
2-dimethylaminoethyl methacrylate (MADAM);
quaternized 2-dimethylaminoethyl methacrylate (MADAM-Quat);
2-diethylaminoethyl methacrylate quaternized in chloride form known as PLEXIMON 735 or MAE MC 80 by Röhm;
diallyldimethylammonium chloride (DADMAC);
trimethyl ammonium propyl methacrylamide in chloride form known as MAPTAC; and
mixtures thereof.

42. The process as defined by claim 35, wherein the cationic or cationizable groups are combined with negatively charged counter ions selected from the group consisting of chloride, bromide, iodide, fluoride, sulfate, methylsulfate, phosphate, hydrogenphosphate, phosphonate, carbonate, hydrogencarbonate and hydroxide ions.

43. The process as defined by claim 35, wherein the degree of substitution is of a vegetable gum modified via the introduction of one or more cationic groups and is at least 0.01

44. The process as defined by claim 28, wherein the polysaccharide is modified to make it insoluble.

45. The process as defined by claim 44, wherein the insoluble polysaccharide is obtained via chemical crosslinking of a vegetable gum, or by chemically or physically adsorbing same onto a mineral or organic support that is insoluble in water.

46. The process as defined by claim 45, wherein the insoluble polysaccharide is obtained via chemical crosslinking.

47. The process as defined by claim 46, wherein the chemical crosslinking is obtained by the action of a crosslinking agent selected from the group consisting of formaldehyde, glyoxal, halohydrins, epichlorohydrin, epibromohydrin, phosphorus oxychloride, polyphosphates, diisocyanates, bisethyleneurea, polyacids, adipic acid, citric acid, acrolein, and mixtures thereof.

48. The process as defined by claim 46, wherein the chemical crosslinking is obtained by the action of a metal complexing agent.

49. The process as defined by claim 45, wherein the chemical crosslinking is obtained by ionizing radiation.

50. The process as defined by claim 46, wherein the crosslinking is carried out until the mass fraction of soluble organics in the polysaccharide is less than 10%.

51. The process as defined by claim 28, wherein the polysaccharide is in powder form or in granule form.

52. The process as defined by claim 28, wherein an optionally modified and optionally insoluble polysaccharide is mixed with at least one other trapping agent.

53. The process as defined by claim 28, wherein an optionally modified and optionally insoluble polysaccharide is mixed with an inert filler.
